(19) United States
(12) Patent Application Publication
(10) Pub. No.: US 2013/0220063 A1
(43) Pub. Date: Aug. 29, 2013

(54) SWITCH DEVICE

(71) Applicants: Koji Mori, Aichi (JP); Yuichi Fujii, Aichi (JP)

(72) Inventors: Koji Mori, Aichi (JP); Yuichi Fujii, Aichi (JP)

(73) Assignee: OMRON AUTOMOTIVE ELECTRONICS CO., LTD., Aichi (JP)

(21) Appl. No.: 13/780,623

(22) Filed: Feb. 28, 2013

(30) Foreign Application Priority Data
Feb. 28, 2012 (JP) 2012-042514
Feb. 28, 2012 (JP) 2012-042515

(51) Int. Cl. G05G 1/04

(52) U.S. Cl. CPC G05G 1/04
USPC 74/523

(57) ABSTRACT

A switch device has a container that contains a contact therein, a rectangular frame-like cylinder disposed at an upper portion of the container, an operating knob that closes an opening formed at an upper end of the cylinder, is pivotally supported by the cylinder via a shaft, and is pivotally operated to open or close the contact, and plungers disposed on both side walls of the cylinder, vertical to a pivotal surface of the operating knob, across the lateral width of the side walls. Each of the plungers projects from one out of the side wall of the cylinder and the side wall of the operating knob, corresponding to the side wall of the cylinder, so as to be linearly brought into elastic contact with the other side wall across the lateral width irrespective of a pivotal state of the operating knob.

### BACKGROUND OF THE INVENTION

1. Technical Field

The present invention relates to a waterproof structure for a switch device provided with a contact that is opened or closed by the operation of an operating knob.

2. Related Art

A switch device provided with a contact that is opened or closed by the operation of an operating knob may include a structure for bringing about a crisp feel (a clicking feeling) during the operation of the operating knob in order to enhance an operating feeling.

Japanese Unexamined Patent Publication No. 2002-75128, for example, discloses a mechanism, in which an operating knob is pivotally fitted to a switch body, and further, a V-shaped crisp surface and a stopper are disposed under the operating knob and at the upper surface of the switch body. Moreover, a coil spring and a ball are disposed in a cylindrical portion projecting from the lower surface of the operating knob, so that the coil spring brings the ball into elastic contact with the crisp surface. The pivotal operation of the operating knob allows a crisp piece to slide on the crisp surface, thus bringing about a crisp feel.

Additionally, Japanese Unexamined Patent Publication No. 2006-210221, for example, discloses a mechanism, in which a cam surface is disposed slantwise on a wall of a supporter inside of a container (i.e., a support member), a rotor is pivotally supported by the supporter via a shaft, and an operating knob is fixed to a projection projecting upward of the rotor. Moreover, a coil spring and a holder are disposed at a cylindrical urging portion projecting slantwise downward of the rotor, so that a ball disposed at the tip of the holder is brought into elastic contact with the cam surface by the coil spring. The pivotal operation of the operating knob and the rotor allows the ball to slide on the cam surface, thus bringing about a crisp feel.

In addition, Japanese Unexamined Patent Publication No. 2004-51089, for example, discloses a switch, in which an operating knob (i.e., a toggle) is housed inside of a rectangular container (i.e., a base), and then, the operating knob is pivotally supported inside of the container via a pin. A plate-like click member having an opening is connected between a side wall of a container, vertically erected with respect to a pivotal surface of the operating knob, and a side surface of the operating knob. A coil spring and a ball are disposed in the operating knob, so that the coil spring brings the ball into elastic contact with the click member. With the pivotal operation of the operating knob, the ball allows the click member to slide so as to fit to the opening, thus bringing about a crisp feel.

Japanese Unexamined Patent Publication No. 2004-146069, for example, discloses a switch, in which a rectangular frame-like cylinder is disposed in an upper portion of a container (i.e., a casing), and an operating knob is pivotally supported by the cylinder via a shaft in such a manner as to close an opening formed at the upper end of the cylinder. Moreover, plate-like drive units are disposed in the vicinity of both side walls of the cylinder, the side wall being perpendicular to a pivotal surface of the operating knob. The lower end of each of the drive units is supported by an operating plate whereas the upper end of each of the drive units abuts against a rib formed inside of the operating knob. Additionally, a click rubber covering a contact is disposed under the operating plate. The pivotal operation of the operating knob presses the drive unit against the rib, so as to elastically deform the operating plate, and further, buckle and deform the click rubber, thus bringing about a crisp feel.

Japanese Unexamined Patent Publication No. 8-293222, for example, discloses a switch, in which the upper portion of a container (i.e., a housing cover) is covered with a switch cover made of a silicone rubber, and further, a contact is covered with an elastic flexure portion of the switch cover. A panel is fixed to the upper portion of the container, and further, an operating knob is pivotally fixed to the inside of a panel fixing hole via a shaft. Moreover, both operating units projecting downward of the operating knob abut on the elastic flexure portion of the switch cover. The pivotal operation of the operating knob allows the operating unit to buckle and deform the elastic flexure portion, thus bringing about a crisp feel.

Since an electric contact or circuit is housed inside of a container for a switch device, the contact or circuit is short-circuited when water or the like (including other liquids) intrudes, thus inducing a malfunction, corrosion, or a failure.

The structure disclosed in, for example, Japanese Unexamined Patent Publication No. 2002-75128 does not take measurements for preventing water intrusion into the operating knob or the switch body. Therefore, when the structure is exposed to water, water readily reaches the contact. Moreover, in the structure disclosed in Japanese Unexamined Patent Publication No. 2006-210221, water readily intrudes into the container through between the operating knob and the container (i.e., the support member) and through a hole formed at the supporter. Furthermore, also in the structure disclosed in Japanese Unexamined Patent Publication No. 2004-51089, water readily intrudes into the container through between the operating knob and the end wall of the container.

Additionally, in the structure disclosed in Japanese Unexamined Patent Publication No. 8-293222, after water intrudes through between the panel and the operating knob, the water flows along the switch cover, thereby raising a fear of intrusion of the water into a housing through a mated surface between the side surfaces of the container.

In contrast, in the structure disclosed in Japanese Unexamined Patent Publication No. 2004-146069, the side wall of the cylinder functions in such a manner as to prevent any intrusion of water into the container. However, predetermined clearances are defined between both side walls of the cylinder and both side walls of the operating knob, in which the side walls are perpendicular to the pivotal surface of the operating knob, so as to secure a space when the operating knob is pivoted. Consequently, water raises through between the side wall of the operating knob and the side wall of the cylinder, and then, intrudes into the container through the clearance defined between the side wall of the cylinder and the drive unit or through between a step defined at the upper end of the drive unit and the rib of the operating knob.

In particular, when the operating knob is pivoted, the drive unit and the inner surface of the operating knob or the rib are gradually separated. Therefore, water goes beyond the drive unit, and then, through the inside of the cylinder, thus raising a fear of intrusion of the water into the container.

### SUMMARY

One or more embodiments of the present invention provides a switch device capable of preventing any intrusion of liquid into the inside of a container through between an operating knob and a cylinder, even if the switch device is exposed to the liquid such as water.

In accordance with one or more embodiments of the present invention, a switch device includes: a container that contains a contact therein; a rectangular frame-like cylinder disposed at an upper portion of the container; an operating knob that closes an opening formed at an upper end of the cylinder, is pivotally supported by the cylinder via a shaft, and is pivotally operated to open or close the contact; and plungers disposed on both side walls of the cylinder, vertical to a pivotal surface of the operating knob, across the lateral width of the side walls. Each of the plungers projects from one out of the side wall of the cylinder and the side wall of the operating knob, corresponding to the side wall of the cylinder, so as to be linearly brought into elastic contact with the other side wall across the lateral width irrespective of a pivotal state of the operating knob.

With this configuration, the plungers disposed on both side walls of the operating knob, vertical with respect to the pivotal surface of the operating knob, and both side walls of the cylinder, respectively, shield water that flows between the operating knob and the cylinder toward the opening formed at the upper end of the cylinder. Therefore, even if the switch device is exposed to the water, it is possible to prevent any intrusion of the water into the container.

According to one or more embodiments of the present invention, in the above switch device, the side wall of the cylinder, in parallel to the pivotal surface of the operating knob, and the side wall of the operating knob may be brought into linear contact with each other across the lateral width of the side wall of the cylinder.

According to one or more embodiments of the present invention, in the above switch device, each of the plungers may be disposed in parallel onto the horizontal center line of the shaft, wherein the contact force of one of the plungers and the contact force of the other plunger act in directions reverse to each other.

According to one or more embodiments of the present invention, in the above switch device, a crisp portion that slides on the plunger according to the pivotal motion of the operating knob so as to bring about a crisp feel may be formed on the side wall of the cylinder, with which each of the plungers is brought into elastic contact, or the side wall of the operating knob.

According to one or more embodiments of the present invention, in the above switch device, the operating knob may cover the cylinder from above; and the plungers may project from the outside surfaces of the side walls of the cylinder, vertical with respect to the pivotal surface of the operating knob, such that the plungers are linearly brought into elastic contact with the inside surfaces of the side walls of the operating knob, corresponding to the outside surfaces.

According to one or more embodiments of the present invention, the above switch device may further include a restriction wall for restricting a pivotal amount of the operating knob when the operating knob is brought into contact, wherein the contact force of the operating knob with respect to the restriction wall and the contact force of the plunger with respect to the operating knob act in directions reverse to each other.

One or more embodiments of the present invention can provide the switch device capable of preventing any intrusion of a liquid into the container from between the operating knob and the cylinder even if the switch device is exposed to the liquid such as water.

### BRIEF DESCRIPTION OF THE DRAWINGS

FIG. 1 is an exploded perspective view showing a switch device according to a first embodiment of the present invention;

FIG. 2 is a perspective view showing the assembled switch device in FIG. 1;

FIG. 3 is a top view showing the switch device in FIG. 1;

FIG. 4 is a side view showing the switch device in FIG. 1;

FIG. 5 is a cross-sectional view taken along line Y-Y in FIG. 4;

FIGS. 6A and 6B are perspective views showing the vicinity of a cylinder in the switch device in FIG. 1;

FIGS. 7A to 7E are cross-sectional views taken along line X-X in FIG. 3;

FIGS. 8A to 8C are enlarged views showing the vicinity of an operating knob in the switch device in FIG. 1;

FIGS. 9A to 9C are views showing the state in which a contact in the switch device in FIG. 1 is opened or closed;

FIG. 10 is a cross-sectional view showing a modification of the first embodiment;

FIG. 11 is a cross-sectional view showing another modification of the first embodiment;

FIG. 12 is an exploded perspective view showing a switch device according to a second embodiment of the present invention;

FIG. 13 is a perspective view showing the vicinity of a cylinder in the switch device in FIG. 12;

FIGS. 14A to 14E are cross-sectional views showing the switch device in the second embodiment;

FIG. 15 is a cross-sectional view showing a modification of the second embodiment;

FIG. 16 is a cross-sectional view showing another modification of the second embodiment; and

FIG. 17 is a cross-sectional view showing a further modification of the second embodiment.

### DETAILED DESCRIPTION

Embodiments of the present invention will be described below with reference to the attached drawings. In each of the drawings, the same or corresponding constituent elements are designated by the same reference numerals. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

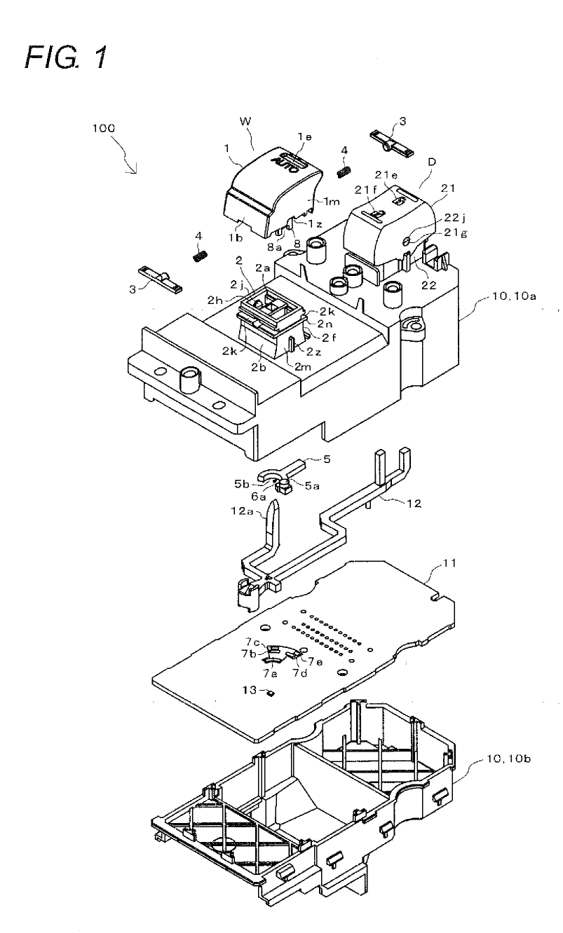

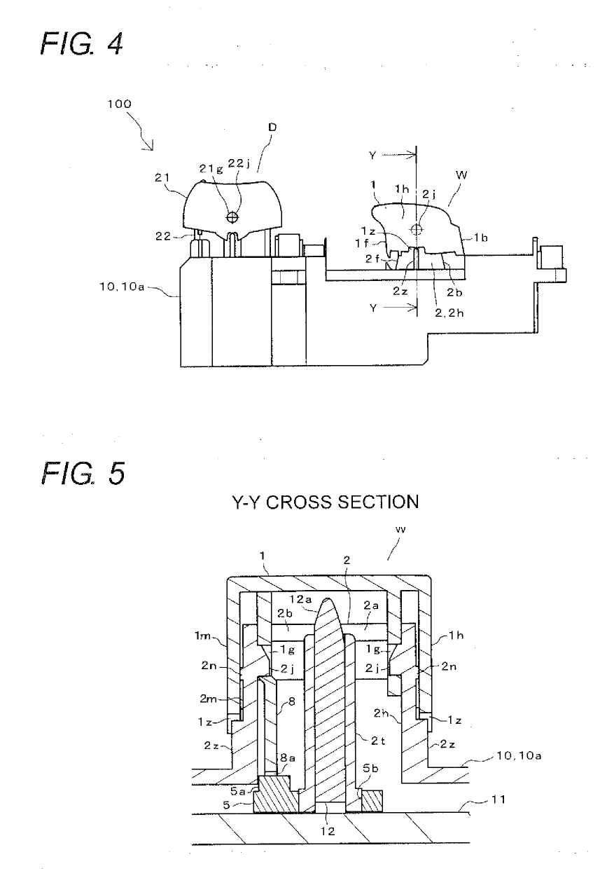

Referring to FIGS. 1 to 4, a switch device 100 in according to one or more embodiments of the present invention is used in a power window system for a vehicle. The switch device 100 is fixed to, for example, an arm rest, not shown, disposed in a door of a passenger's seat. The switch device 100 includes a window switch W and a door lock switch D.

A container 10 for the switch device 100 is constituted of a case 10a and a cover 10b, as shown in FIG. 1. The lower side of the case 10a is opened, and is closed with the cover 10b. The container 10 contains therein a board 11, a light guide 12, and a striker 5.

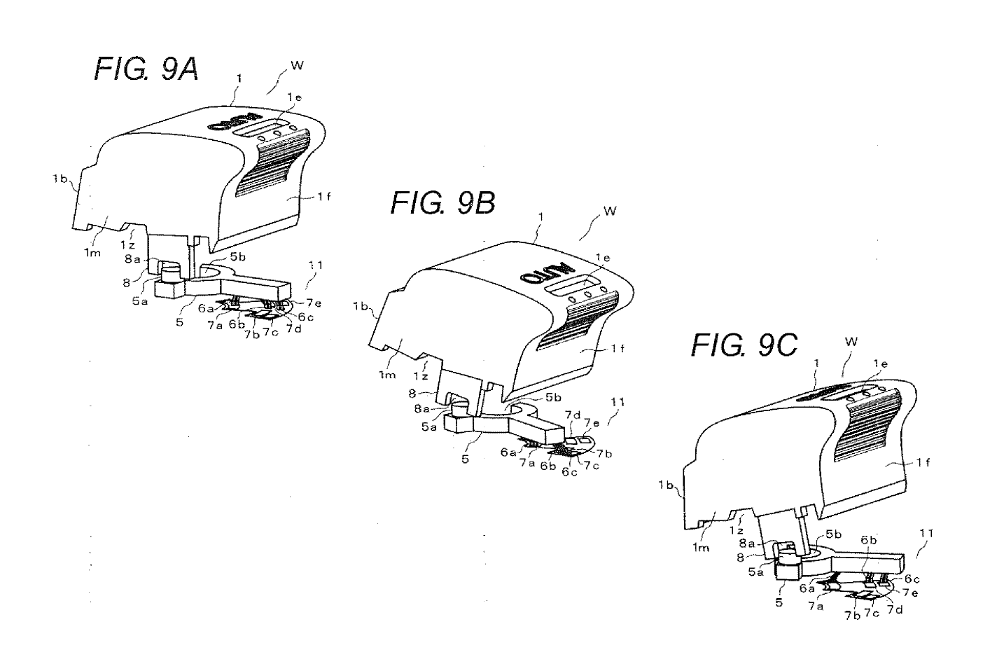

A plurality of fixed contacts 7a to 7e, an LED (abbreviating a light emitting diode) 13, and electronic parts such as other switches and connectors (not shown) are mounted on the board 11. These constituent parts constitute an electric circuit. The striker 5 includes a plurality of movable contacts 6a to 6c formed of disk springs, as shown in FIGS. 9A to 9C.

The light guide 12 shown in FIG. 1 is molded with a light transmission resin such as an acrylic resin. The light guide 12 is adapted to guide light emitted from the LED 13 to a display 1e for the window switch W and displays 21e and 21f for the door lock switch D.

At the upper portion of the container 10, rectangular frame-like cylinders 2 and 22 are disposed integrally with the case 10a. Each of shafts 22j disposed at the outside surface of the cylinder 22 (FIGS. 1 to 3) is inserted into each of holes 21g formed at the side surface of an operating knob 21 in the door lock switch D (FIGS. 1, 2, and 4). And then, the operating knob 21 closes an opening at the upper end of the cylinder 22, to be thus pivotally supported by the cylinder 22 via the shafts 22j, as shown in FIGS. 1 to 4.

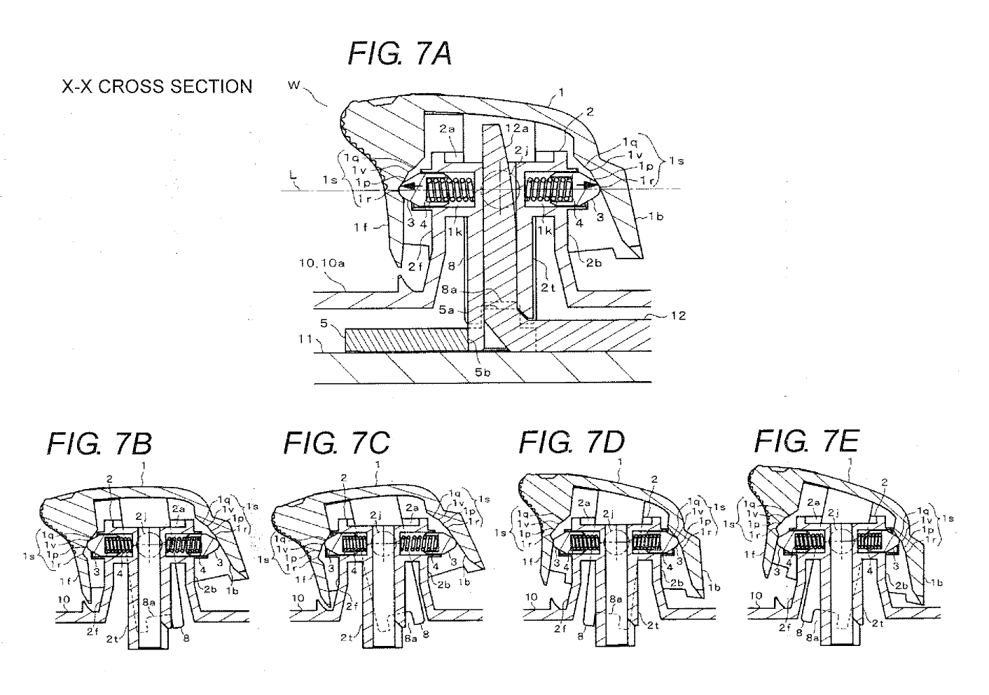

Each of shafts 2j disposed at the inside surface of the cylinder 2 (FIGS. 1, 5, 6A, and 6B) is inserted into each of holes 1g formed at the inside of an operating knob 1 in the window switch W (FIG. 5). As shown in FIGS. 5 and 7A to 7E, the operating knob 1 closes an opening 2a at the upper end of the cylinder 2, to be thus pivotally supported by the cylinder 2 via the shafts 2j. That is to say, the cylinder 2 is covered with the operating knob 1.

A small cylindrical portion 2t is disposed inside of the cylinder 2 (FIGS. 5 to 7E). Moreover, a projection 12a of the light guide 12 penetrates inside of the small cylindrical portion 2t. An arcuate portion 5b of the striker 5 (FIGS. 5, 7A to 7E, and 9A to 9C) is fitted around the lower end of the small cylindrical portion 2t. The striker 5 is mounted in the vicinity of the fixed contacts 7a to 7e on the board 11.

A lever 8 is disposed inside of the operating knob 1 (FIGS. 1, 5, 7A to 7E, and 9A to 9C). The lever 8 penetrates the inside of the cylinder 2. A recess 8a formed at the lower end of the lever 8 is fitted to a convex portion 5a formed at the striker 5.

When the operating knob 1 is pivotally operated on the shafts 2j from a neutral state shown in FIGS. 7A and 9A to states shown in FIGS. 7B to 7E, 9B, and 9C, the lever 8 is tilted, so that the striker 5 is turned along the outer peripheral surface of the small cylindrical portion 2t. Consequently, the movable contacts 6a to 6c disposed in the striker 5 slide on the board 11, to be thus brought into or out of contact with the fixed contacts 7a to 7e. In other words, the pivotal operation of the operating knob 1 allows the movable contacts 6a to 6c and the fixed contacts 7a to 7e to be opened or closed (i.e., OFF or ON).

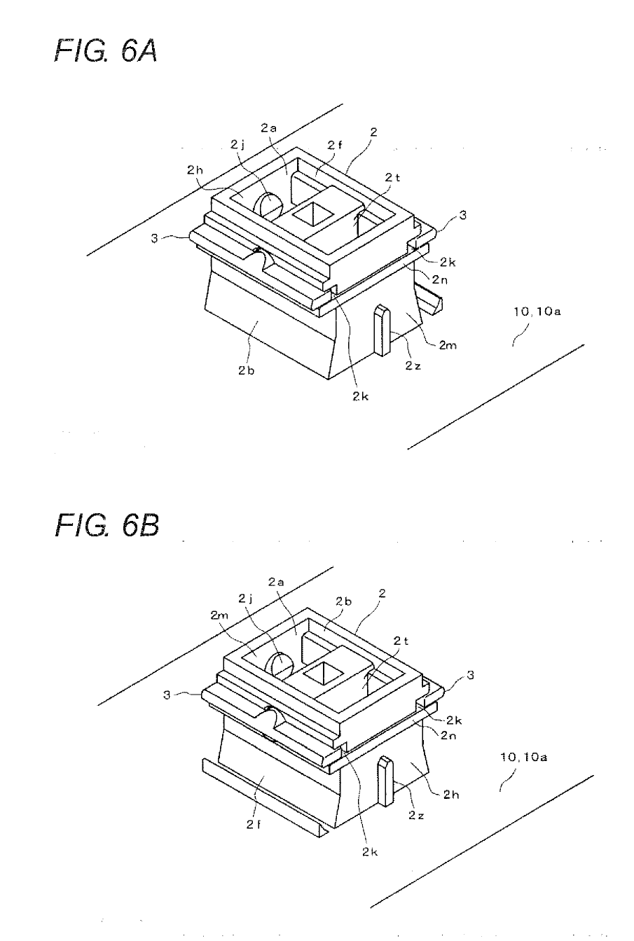

Plungers 3 are disposed respectively on both side walls 2f and 2b of the cylinder 2, vertical with respect to the pivotal surface of the operating knob 1 (i.e., a plane perpendicular to the center axis of the shaft 2j). Each of the plungers 3 is made of a resin, and further, has a width corresponding to the lateral width of each of the side walls 2f and 2b of the cylinder 2, as shown in FIGS. 6A and 6B. That is to say, the lateral width of each of the plungers 3 is greater than or equal to that of each of the side walls 2f and 2b.

As shown in FIGS. 1, 6A, and 6B, a groove 2k is formed across the lateral width of each of the side walls 2f and 2b of the cylinder 2. The plunger 3 is inserted into each of the grooves 2k together with a coil spring 4, and then, the operating knob 1 is fixed to the cylinder 2, as described above. Then, as shown in FIGS. 7A to 7E, each of the plungers 3 projects from each of the side walls 2f and 2b of the cylinder 2 by the resiliency of the coil spring 4, thus to be linearly brought into elastic contact with each of side walls 1f and 1b of the operating knob 1 across the lateral width, wherein the side walls 1f and 1b correspond to the side walls 2f and 2b, respectively. This elastic contact is held irrespective of the pivotal state of the operating knob 1, as shown in FIGS. 7A to 7E. in this manner, each of the plungers 3 functions as a water shielding wall.

Moreover, each of the plungers 3 is disposed in parallel to the horizontal center line L of the shaft 2j. The contact force of one of the plungers 3 and the contact force of the other plunger 3 act on the operating knob 1 in directions reverse to each other, as indicated by bold arrows in FIG. 7A.

A crisp portion 1s is formed on each of the side walls 1f and 1b of the operating knob 1. The crisp portion 1s is constituted of valleys 1r and 1v and peak-like slopes 1p and 1q. The pivotal motion of the operating knob 1 causes the plunger 3 and the crisp portion 1s to slide on each other, thereby bringing about a crisp feel (i.e., a clicking feeling). As a consequence, each of the plungers 3 also functions as a crisp piece.

Specifically, when the operating knob 1 is in the neutral state, the tip of each of the plungers 3 is fitted to the valley 1r of each of the crisp portions 1s, as shown in FIG. 7A. When the operating knob 1 is pivotally operated at a small angle in a forward leaning direction from this neutral state, as shown in FIG. 7B, the tip of the plunger 3 between the side walls 2f and 1f is fitted to the slope 1p of the crisp portion 1s, thereby bringing about a crisp feel. Additionally, when the operating knob 1 is pivotally operated at a large angle in the forward leaning direction, as shown in FIG. 7C, the tip of the plunger 3 between the side walls 2f and 1f is fitted to the slope 1q beyond the valley 1v of the crisp portion 1s, thereby bringing about a crisp feel.

Furthermore, when the operating knob 1 is pivotally operated at a small angle in a rearward leaning direction from the neutral state, as shown in FIG. 7D, the tip of the plunger 3 between the side walls 2b and 1b is fitted to the slope 1p of the crisp portion 1s, thereby bringing about a crisp feel. In addition, when the operating knob 1 is pivotally operated at a large angle in the rearward leaning direction, as shown in FIG. 7E, the tip of the plunger 3 between the side walls 2b and 1b is fitted to the slope 1q beyond the valley 1v of the crisp portion 1s, thereby bringing about a crisp feel.

As shown in FIGS. 6A and 6B, convex portions 2n are formed across the lateral width at outside surfaces of side walls 2m and 2h of the cylinder 2, in parallel to the pivotal surface of the operating knob 1. With the convex portions 2n, the side walls 2m and 2h of the cylinder 2 are brought into linear contact with side walls 1m and 1h of the operating knob 1, corresponding to the side walls 2m and 2h, respectively, across the lateral width of the side walls 2m and 2h of the cylinder 2, as shown in FIG. 5. Waterproof grease, not shown, is applied between the side walls 2m and 2h of the cylinder 2 and the side walls 1m and 1h of the operating knob 1.

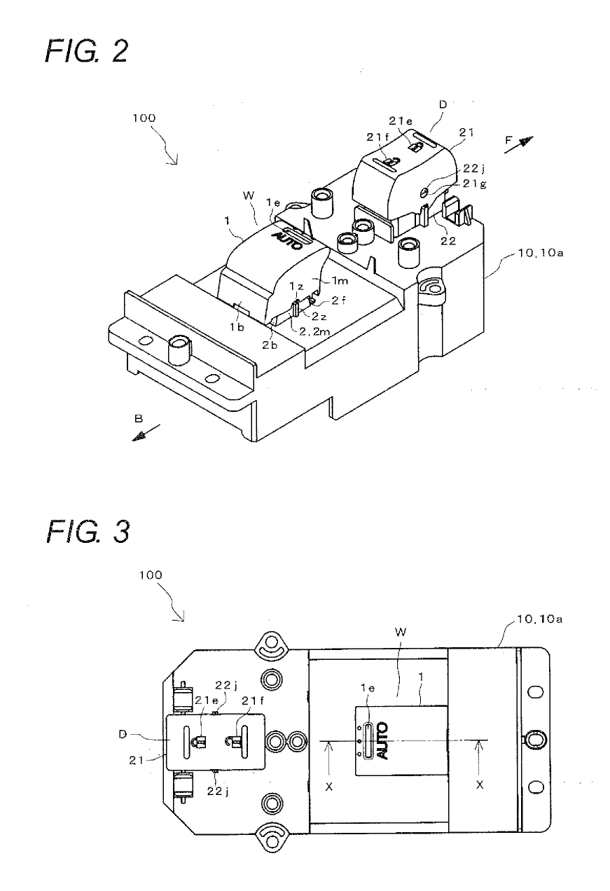

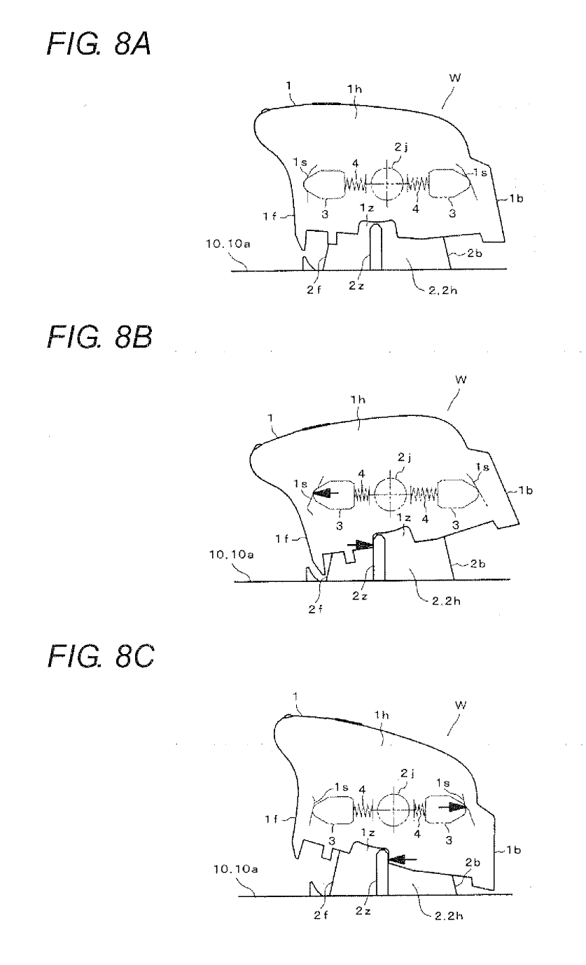

As shown in FIGS. 2, 4, 8A to 8C, and the like, a recess 1z is formed at the lower end of each of the side walls 1m and 1h of the operating knob 1. As shown in FIGS. 6A, 6B, and 8A to 8C, a projecting restriction wall 2z is formed at the lower end of each of the side walls 2m and 2h of the cylinder 2. The upper portion of the restriction wall 2z enters the recess 1z.

As shown in FIGS. 8B and 8C, when the operating knob 1 is pivotally operated from the neutral state shown in FIG. 8A, the side end of the recess 1z of the operating knob 1 is brought into contact with the restriction wall 2z, thus restricting the pivotal amount of the operating knob 1. At this time, the contact force of the operating knob 1 with respect to the restriction wall 2z and the contact force of the plunger 3 with respect to the crisp portion 1 s of the operating knob 1 act in directions reverse to each other, as indicated by bold arrows.

In the above embodiments, the plungers 3 are disposed on both side walls 2f and 2b of the cylinder 2, vertical with respect to the pivotal surface of the operating knob 1 across the lateral width of the side walls 2f and 2b. The plungers 3 project from the side walls 2f and 2b of the cylinder 2, thus to be linearly brought into elastic contact with the side walls 1f and 1b of the operating knob 1, corresponding to the side walls 2f and 2b across the lateral width irrespective of the pivotal state of the operating knob 1. Therefore, the plungers 3 can shield water flowing into the opening 2a at the upper end of the cylinder 2 through between the side walls 1f and 1b of the operating knob 1 and the side walls 2f and 2b of the cylinder 2. Consequently, even if the switch device 100 is exposed to water, water can be prevented from intruding into the container 10.

In the above embodiments, the side walls 2m and 2h of the cylinder 2, in parallel to the pivotal surface of the operating knob 1, and the side walls 1m and 1h of the operating knob 1 are brought into linear contact with each other across the lateral width of the side walls 2m and 2h by the convex portions 2n. As a consequence, it is possible to shield water reaching the opening 2a at the upper end of the cylinder 2 through between the side walls 2m and 2h of the cylinder 2 and the side walls 1m and 1h of the operating knob 1.

In the above embodiments, the plungers 3 are juxtaposed on the horizontal center line L of the shaft 2j, and thus, the contact force of one of the plungers 3 and the contact force of the other plunger 3 act in the directions reverse to each other. In this manner, the pivotal amount of the operating knob 1 in order to provide the crisp feel can become small. Consequently, the height of the switch device 100 is reduced by reducing the height of the operating knob 1 or the cylinder 2 while the plunger 3 can prevent water from intruding into the container 10. Moreover, the contact forces of both of the plungers 3 cancel each other, thereby providing a good balance so as not to influence the operability of the operating knob 1. Additionally, it is possible to facilitate the design of each of the constituent parts for the purpose of secureness of the operability of the operating knob 1.

In the above embodiments, the crisp portion 1s is provided on each of the side walls 1f and 1b of the operating knob 1, with which each of the plungers 3 is brought into elastic contact. As a consequence, the crisp feel can be brought about during the pivotal operation of the operating knob 1, so that the operating knob 1 can be returned to the neutral state when the operation is released while enhancing operational feeling. Moreover, the plunger 3 functions as both the water shielding wall and the crisp piece, and therefore, it is unnecessary to provide a crisp portion or a crisp piece in an inside space of the cylinder or the container, unlike the conventional art, thus effectively utilizing the inside space of the cylinder 2 or the container 10 for other purposes.

Specifically, in the above embodiments, the light guide 12 and the lever 8 are housed inside of the cylinder 2, and further, the striker 5 and the contacts 6a to 6c and 7a to 7e are housed inside of the container 10 in the vicinity. As a result, the constituent parts can be compactly packaged, thereby miniaturizing the switch device 100. The door lock switch D has an outer fitting structure in which the shaft 22j and the hole 21g are exposed to the outside, wherein the operating knob 21 is fitted to the cylinder 22. In contrast, the window switch W has an inner fitting structure in which the shaft 2j and the hole 1g are provided inside of the cylinder 2 and the operating knob 1, wherein the operating knob 1 is fitted to the cylinder 2. Thus, it is possible to suppress a crack of the operating knob 1 from occurring or grease applied between the side walls 1m and 1h of the operating knob 1 and the side walls 2m and 2h of the cylinder 2 from oozing.

Furthermore, in the above embodiments, the cylinder 2 is covered with the operating knob 1, and further, the plungers 3 project from the outside surfaces of the side walls 2f and 2b of the cylinder 2, thus to be linearly brought into elastic contact with the inside surfaces of the side walls 1f and 1b of the operating knob 1. In this manner, it is possible to reduce the width of the operating knob 1 or the cylinder 2 in the direction parallel to the pivotal surface of the operating knob 1.

Moreover, in the above embodiments, the contact force of the operating knob 1 with respect to the restriction wall 2z and the contact force of the plunger 3 with respect to the operating knob 1 act in the directions reverse to each other. Consequently, the contact force of the operating knob 1 with respect to the restriction wall 2z and the contact force of the plunger 3 with respect to the operating knob 1 cancel each other, thus reducing a collision noise occurring when the operating knob 1 collides against the restriction wall 2z during the pivotal operation of the operating knob 1.

The present invention includes various embodiments other than the above-described embodiments. For example, although the plungers 3 project from the side walls 2f and 2b of the cylinder 2, vertical to the pivotal surface of the operating knob 1, thus to be lineally brought into elastic contact with the side walls 1f and 1b of the operating knob 1 in the above embodiments, the present invention is not limited to this.

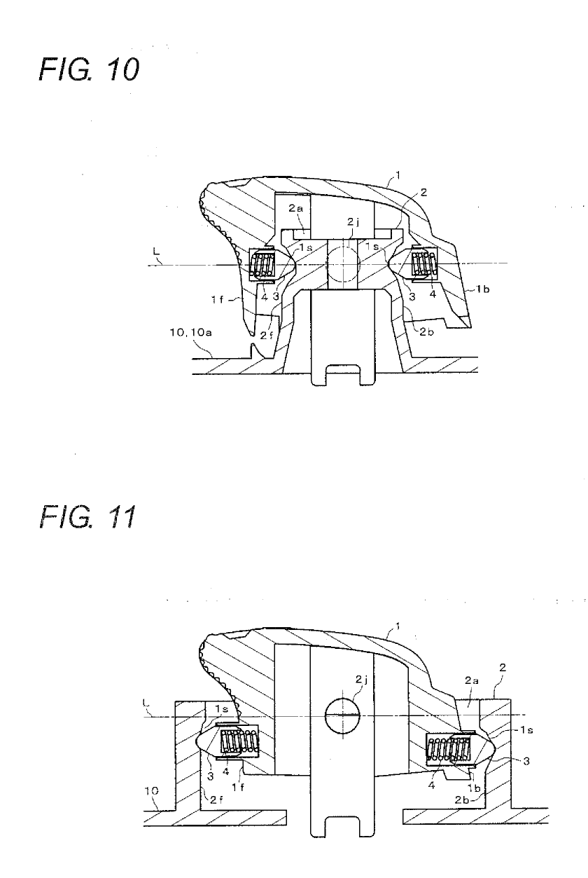

As shown in, for example, FIG. 10, plungers 3 may project from the inside surfaces of side walls 1f and 1b of an operating knob 1, vertical with respect to the pivotal surface of the operating knob 1, thus to be lineally brought into elastic contact with the outside surfaces of side walls 2f and 2b of a cylinder 2. In this case, crisp portions 1s are formed at the outside surfaces of the side walls 2f and 2b of the cylinder 2, thus bringing about a crisp feel during the pivotal operation of the operating knob 1.

As shown in, for example, FIG. 11, plungers 3 may project from the outside surfaces of side walls 1f and 1b of an operating knob 1, vertical with respect to the pivotal surface of the operating knob 1, thus to be lineally brought into elastic contact with the inside surfaces of side walls 2f and 2b of a cylinder 2. Alternatively, the plungers 3 may be located at positions apart from the horizontal center line L of a shaft 2j.

Further, the plungers 3 may be disposed slantwise with respect to the horizontal center line L of the shaft 2j. Furthermore, one of the plungers 3 may project from either one of the side walls 1f and 1b of the operating knob 1, thus to be lineally brought into elastic contact with the side walls 2f and 2b of the cylinder 2: in contrast, the other plunger 3 may project from either one of the side walls 2f and 2b of the cylinder 2, thus to be lineally brought into elastic contact with the side walls 1f and 1b of the operating knob 1.

Additionally, although the crisp portions 1s are formed on the side walls 1f and 1b of the operating knob 1 in the above embodiments, the crisp portions 1s may be omitted. In other words, the plungers 3 may be used only as the water shielding walls. In this case, a coil spring 4 also is omitted. The plunger 3 may be made of an elastic material such as rubber, so that the plunger 3 may be brought into elastic contact with the side walls 1f and 1b of the operating knob 1 by its own elastic force.

In addition, in the above embodiments, the side walls 2m and 2h of the cylinder 2 parallel to the pivotal surface of the operating knob 1 and the side walls 1m and 1h of the operating knob 1 are allowed to be brought into linear contact with each other by the convex portions 2n across the lateral width of the side walls 2m and 2h. However, the present invention is not limited to this. For example, side walls 2m and 2h of a cylinder 2 and side walls 1m and 1h of an operating knob 1 may be allowed to be brought into surface contact with each other, thus providing a portion in local linear contact.

One or more embodiments of the present invention will be described below with reference to the attached drawings. Here, the same or corresponding constituent elements as or to those shown in FIGS. 1 to 11 are designated by the same reference numerals.

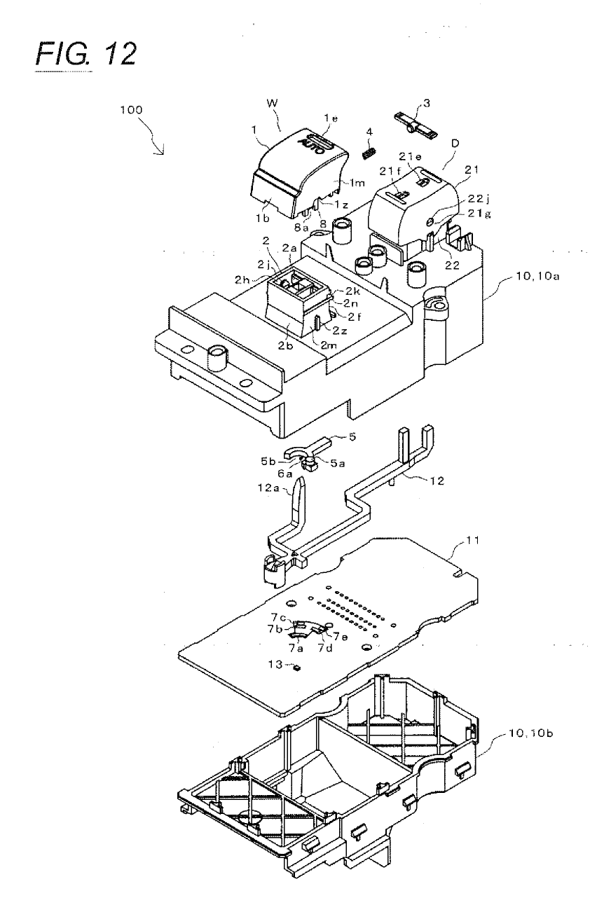

Referring to FIGS. 12 to 14, a switch device 100 according to one or more embodiments of the present invention is used in a power window system for an automobile. The switch device 100 is fixed to, for example, an arm rest, not shown, disposed in a passenger's seat. The switch device 100 includes a window switch W and a door lock switch D.

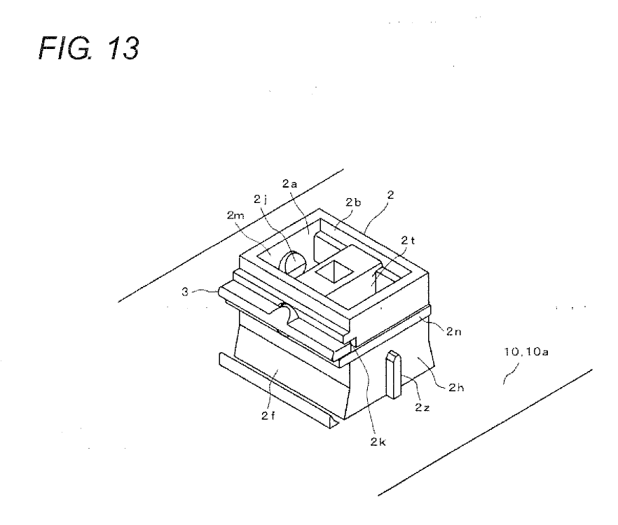

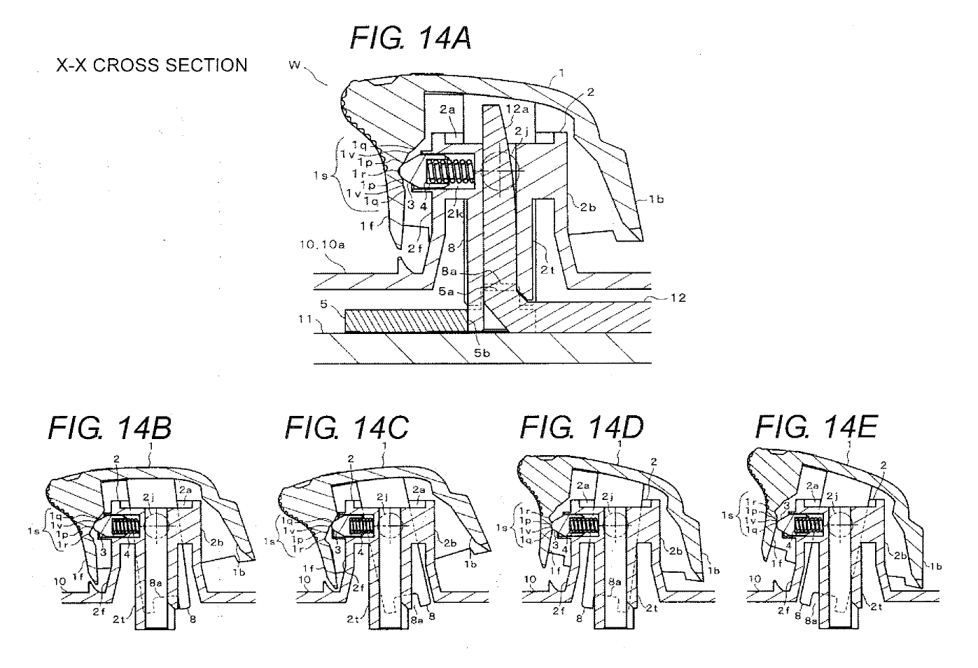

As shown in FIGS. 12 and 13, a groove 2k is formed on a side wall 2f of a cylinder 2 across a lateral width. A plunger 3 is inserted into the groove 2k together with a coil spring 4, and then, an operating knob 1 is fitted to the cylinder 2, as described above. Then, as shown in FIG. 14, the plunger 3 projects from the side wall 2f of the cylinder 2 by the elastic force of the coil spring 4, thus to be linearly brought into elastic contact with a side wall 1f of the operating knob 1, corresponding to the side wall 2f, across the lateral width. This elastic contact can be held irrespective of the pivotal state of the operating knob 1, as shown in FIGS. 7A to 7E. In this manner, the plunger 3 functions as a water shielding wall.

In particular, in one or more embodiments, the plunger 3 is interposed between the side wall 2f located forward F (FIGS. 2 and 14A to 14E), out of the side walls 2f and 2b of the cylinder 2, and the side wall 1f of the operating knob 1. Therefore, when the switch device 100 is attached to an arm rest in a rearward leaning attitude (i.e., the window switch W becomes lower than the door lock switch D), the plunger 3 can securely shut off water that flows down on the top of a tilted container 10 into an opening 2a formed at the upper end of the cylinder 2 through between the side walls 1f and 2f.

The present invention include various embodiments other than the above embodiments. For example, although the plunger 3 projects from the side wall 2f of the cylinder 2, vertical to the pivotal surface of the operating knob 1, thus to be lineally brought into elastic contact with the side wall 1f of the operating knob 1 in the above embodiments, the present invention is not limited to this.

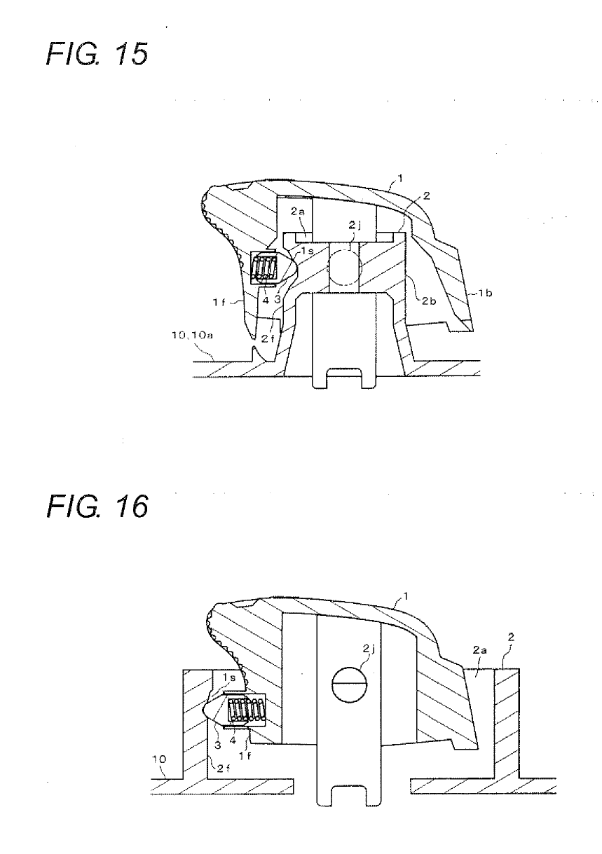

As shown in, for example, FIG. 15, a plunger 3 may project from the inside surface of a side wall 1f of an operating knob 1, vertical with respect to the pivotal surface of the operating knob 1, thus to be lineally brought into elastic contact with the outside surface of a side wall 2f of a cylinder 2. In this case, a crisp portion 1s is formed at the outside surface of the side wall 2f of the cylinder 2, thus bringing about a crisp feel during the pivotal operation of the operating knob 1.

As shown in, for example, FIG. 16, a plunger 3 may project from the outside surface of a side wall 1f of an operating knob 1, vertical with respect to the pivotal surface of the operating knob 1, thus to be lineally brought into elastic contact with the inside surface of a side wall 2f of a cylinder 2.

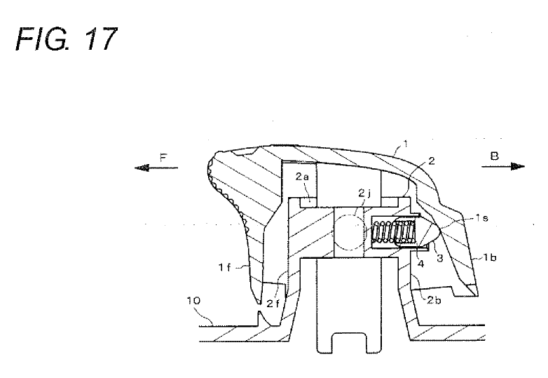

Alternatively, for example, the plunger 3 may be interposed between the side wall 2b located rearward B, out of the side walls 2f and 2b of the cylinder 2, and the side wall 1b of the operating knob 1, as shown in FIG. 17.

In this case, when the switch device 100 is attached to an arm rest in a forward leaning attitude (i.e., the window switch W becomes higher than the door lock switch D), the plunger 3 can securely shut off water that flows down on the top of the tilted container 10 into the opening 2a formed at the upper end of the cylinder 2 through between the side walls 1b and 2b.

Furthermore, although one or more embodiments of the present invention is applied to the window switch W in the switch device 100 for use in the power window system in the above embodiments, one or more embodiments of the present invention is applicable to the door lock switch D. In addition, one or more embodiments of the present invention is applicable to a switch device for usages other than the vehicle-mounted usage.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A switch device comprising:
a container that contains a contact therein;
a rectangular frame-like cylinder disposed at an upper portion of the container;
an operating knob that closes an opening formed at an upper end of the cylinder, is pivotally supported by the cylinder via a shaft, and is pivotally operated to open or close the contact; and
plungers disposed on both side walls of the cylinder, vertical to a pivotal surface of the operating knob, across the lateral width of the side walls;
wherein each of the plungers projects from one out of the side wall of the cylinder and the side wall of the operating knob, corresponding to the side wall of the cylinder, so as to be linearly brought into elastic contact with the other side wall across the lateral width irrespective of a pivotal state of the operating knob.

2. The switch device according to claim 1, wherein
the side wall of the cylinder, in parallel to the pivotal surface of the operating knob, and the side wall of the operating knob are brought into linear contact with each other across the lateral width of the side wall of the cylinder.

3. The switch device according to claim 1, wherein
each of the plungers is disposed in parallel onto a horizontal center line of the shaft,
the contact force of one of the plungers and the contact force of the other plunger acting in directions reverse to each other.

4. The switch device according to claim 1, wherein
a crisp portion that slides on the plunger according to the pivotal motion of the operating knob so as to bring about a crisp feel is formed on the side wall of the cylinder, with which each of the plungers is brought into elastic contact, or the side wall of the operating knob.

5. The switch device according to claim 1, wherein
the operating knob covers the cylinder from above; and
the plungers project from the outside surfaces of the side walls of the cylinder, vertical with respect to the pivotal surface of the operating knob, such that the plungers are linearly brought into elastic contact with the inside surfaces of the side walls of the operating knob, corresponding to the outside surfaces.

6. The switch device according to claim 5, further comprising a restriction wall for restricting a pivotal amount of the operating knob when the operating knob is brought into contact,
wherein the contact force of the operating knob with respect to the restriction wall and the contact force of the plunger with respect to the operating knob act in directions reverse to each other.

7. A switch device comprising:
a container that contains a contact therein;
a rectangular frame-Like cylinder disposed at an upper portion of the container;
an operating knob that closes an opening formed at an upper end of the cylinder, is pivotally supported by the cylinder via a shaft, and is pivotally operated to open or close the contact; and
a plunger disposed on either one of side walls of the cylinder, vertical to a pivotal surface of the operating knob, across the lateral width of the side wall;
wherein the plunger projects from one out of the side wall of the cylinder and the side wall of the operating knob, corresponding to the side wall of the cylinder, so as to be linearly brought into elastic contact with the other side wall across the lateral width irrespective of a pivotal state of the operating knob.

8. The switch device according to claim 7, wherein
the side wall of the cylinder, in parallel to the pivotal surface of the operating knob, and the side wall of the operating knob are brought into linear contact with each other across the lateral width of the side wall of the cylinder.

9. The switch device according to claim 7, wherein
a crisp portion that slides on the plunger according to the pivotal motion of the operating knob so as to bring about a crisp feel is formed on the side wall of the cylinder, with which each of the plungers is brought into elastic contact, or the side wall of the operating knob.

10. The switch device according to claim 7, wherein
the operating knob covers the cylinder from above; and
the plungers project from the outside surfaces of the side walls of the cylinder, vertical with respect to the pivotal surface of the operating knob, such that the plungers are linearly brought into elastic contact with the inside surfaces of the side walls of the operating knob, corresponding to the outside surfaces.
